(19) United States
(12) Patent Application Publication
(10) Pub. No.: US 2012/0105715 A1
(43) Pub. Date: May 3, 2012

(54) DISPLAY APPARATUS AND METHOD FOR INFORMING NEXT PROGRAM OF BROADCASTING CHANNEL USING THE SAME

(75) Inventor: Young Chul Kim, Special Self Governing Province (KR)

(73) Assignee: LG INNOTEK CO., LTD., Seoul (KR)

(21) Appl. No.: 13/259,965

(22) PCT Filed: Mar. 31, 2010
(86) PCT No.: PCT/KR10/01983

§ 371 Date: Jan. 17, 2012

(30) Foreign Application Priority Data
Apr. 2, 2009 (KR) 10-2009-0028636

(51) Int. Cl. H04N 11/02; H04N 5/445

(52) U.S. Cl. 348/384.1; 348/563; 348/E11.006; 348/E05.099

(57) ABSTRACT

The present invention relates to an displaying apparatus comprising: a signal converting unit demodulating a digital signal generated by a tuner and encodes an analog signal decoded by the tuner; a decoding unit decoding the demodulated digital signal or the encoded analog signal to generate an image signal or a voice signal; a storing unit storing the image signal or the voice signal; a broadcast program processing unit providing information of a next program using the image signal or the voice signal while a current program is broadcasted; a controlling unit controlling the decoding unit and the broadcast program processing unit; and a displaying unit displaying information of the next program on broadcasting the current program under the control of the controlling unit.

### TECHNICAL FIELD

The present invention relates to a display apparatus and a method for informing a next program of broadcasting channel using the same.

### BACKGROUND ART

Generally, in a conventional displaying apparatus, there is a defect that a use has to push a information button to catch up information of a next program. Since the conventional displaying apparatus cannot graphically shows information regarding remaining hours up to the next program begins, there is a limitation in providing a convenient service to viewers watching a program.

### DISCLOSURE OF INVENTION

Technical Problem

A display apparatus and a method for informing a next program of broadcasting channel using the same according to the present invention previously provide information in advance regarding the next program to be broadcasted to viewers.

A method for informing a next program of broadcasting channel using a display apparatus according to the present invention also provide information in advance regarding the next program to be broadcasted into a portable display apparatus.

Solution to Problem

In one general aspect of the present invention, there is provided a displaying apparatus comprising: a signal converting unit demodulating a digital signal generated by a tuner and encoding an analog signal decoded by the tuner; a decoding unit decoding the demodulated digital signal or the encoded analog signal to generate an image signal or a voice signal; a storing unit storing the image signal or the voice signal; a broadcast program processing unit providing information of a next program using the image signal or the voice signal while a current program is broadcasted; a controlling unit controlling the decoding unit and the broadcast program processing unit; and a displaying unit displaying the information of the next program on broadcasting the current program under the control of the controlling unit.

In some exemplary embodiments, the displaying unit displays a current program and the information of the next program with one monitor during a predetermined time before the next program begins.

In some exemplary embodiments, the display apparatus further comprises an interfacing unit transmitting the image signal and voice signal provided by the broadcast program processing unit to the controlling unit such that the image signal and voice signal are displayed on the displaying unit wherein the broadcast program processing unit is implemented as a portable unit.

In some exemplary embodiments, the information of the next program includes at least one selected from a group consisting of information about a title of the next program, remaining hours up to the next program, and an image regarding the next program.

In some exemplary embodiments, the displaying unit has a touch screen function and a displaying position of the information of the next program and a displaying position of the current program is exchanged by touching of a point of the displaying unit.

In some exemplary embodiments, the signal converting unit includes: a demodulator demodulating the digital signal provided by the tuner; an analog decoder decoding the analog signal provided by the tuner; and an encoder encoding the decoded signal by the analog decoder.

In some exemplary embodiments, the decoding unit includes: a system decoder decoding the demodulated digital signal provided by the demodulator to generate a decoded digital signal or an encoded analog signal provided by the encoder to generate a decoded analog signal; and an image/voice decoding unit decoding the decoded digital signal or decoded analog signal provided by the system decoder to generate the image signal or voice signal.

In some exemplary embodiments, the controlling unit includes a system controlling unit controlling the system decoder; and an image/voice controlling unit controlling the image/voice controlling unit and the broadcast program processing unit.

In some exemplary embodiments, the displaying unit includes at least one selected from a group consisting of PMP, PDA, PDP, LCD, and OLED.

In another general aspect of the present invention, a method for displaying a next program of a broadcast channel, comprising: storing a program data of a current broadcasting channel; extracting broadcasting information of the next program; selecting whether the broadcasting information of the next program is displayed; loading information of the current broadcasting program; calculating a remaining time until the next program is broadcasted; checking whether the calculated remaining time is within a predetermined time; and displaying the broadcasting information of the next program if the calculated remaining time is within a predetermined time.

In some exemplary embodiments, the predetermined time is 10 minutes and the broadcasting information of the next program is displayed at a ratio of 4:3.

### ADVANTAGEOUS EFFECTS OF INVENTION

A display apparatus and a method for informing next program of broadcasting channel using the same according to the present invention can previously provide information regarding the next program to be broadcasted to viewers. Thus, it can enhance a quality of service for providing broadcasting information.

A method for informing next program of broadcasting channel using a display apparatus according to the present invention can also provide information in advance regarding the next program to be broadcasted into a portable display apparatus. Thus, it can further enhance a quality of service for providing broadcasting information.

### BRIEF DESCRIPTION OF DRAWINGS

FIG. 1 is an exemplified diagram of a displaying apparatus according to a first embodiment of the present invention.

FIG. 2 is a detail diagram of the displaying apparatus in FIG. 1.

FIG. 3 is a diagram of a displaying unit in the displaying apparatus in FIG. 1.

FIG. 4 is a flow chart representing a method for showing a next program a displaying apparatus according to a first embodiment of the present invention.

FIG. 5 is an exemplified diagram of displaying apparatus according to a second embodiment of the present invention.

FIG. 6 is a detail diagram of the displaying apparatus in FIG. 5.

### BEST MODE FOR CARRYING OUT THE INVENTION

Configuration and operation of the present invention will be described in detail with reference to the accompanying drawings.

(First Embodiment)

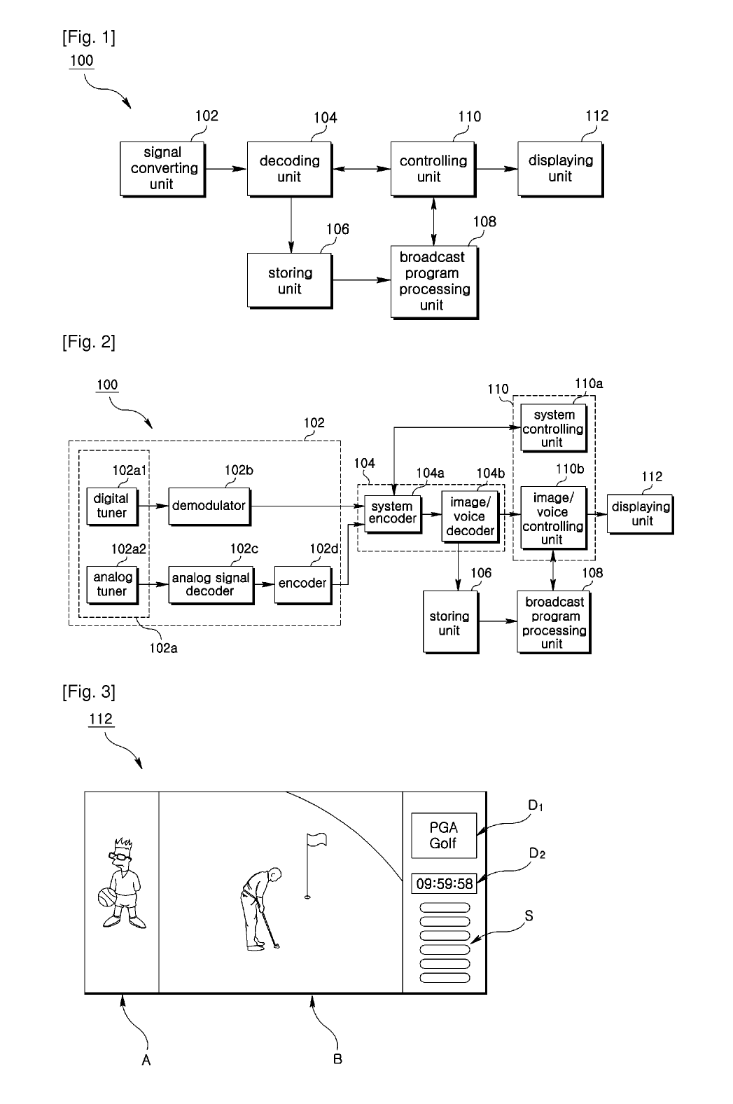

Hereinafter, a first exemplary embodiment according to the present invention will be described referring to FIGS. 1 to FIG. 4.

FIG. 1 is an exemplified diagram of a displaying apparatus according to a first embodiment of the present invention. FIG. 2 is a detail diagram of the displaying apparatus in FIG. 1. FIG. 3 is a diagram of a displaying unit in the displaying apparatus in FIG. 1.

Referring to FIGS. 1 to 3, the displaying apparatus according to a first embodiment includes a signal converting unit 102, a decoding unit 104, a storing unit 106, a broadcast program processing unit 108, a controlling unit 110, and a displaying unit 112.

The signal converting unit 102 demodulates a digital signal generated by a tuner 102a and encodes an analog signal decoded by the tuner 102a.

The tuner 102a includes the digital tuner 102a1 and the analog tuner 102a2.

The signal converting unit 102 includes the tuner 102a, a demodulator 102b, an analog signal decoder 102c, and an encoder 102d.

The demodulator 102b demodulates a digital signal provided by the digital tuner 102a. The analog signal decoder 102c decodes an analog signal provided by the analog tuner 102a2. The encoder 102d encodes an analog signal decoded by the analog signal decoder 102c.

The decoding unit 104 includes a system decoder 104a and an image/voice decoding unit 104b.

The system decoder 104a decodes a demodulated digital signal provided by the demodulator 102b to generate a decoded digital signal or an encoded analog signal provided by the encoder 102d to generate a decoded analog signal.

The image/voice decoding unit 104b decodes the decoded digital signal or decoded analog signal provided by the system decoder 104a to generate an image signal or voice signal.

The storing unit 106 selectively stores the image signal or voice signal provided by the image/voice controlling unit 104b. The broadcast program processing unit 108 receives the image signal or voice signal to provide a next broadcast information data which is displayed on broadcasting a current program.

The controlling unit 110 controls the decoding unit 104 and the broadcast program processing unit 108. Especially, the controlling unit 110 controls the broadcast program processing unit 108 to display a next broadcast information data on broadcasting a current program.

The controlling unit 110 includes a system controlling unit 110a and an image/voice controlling unit 110b.

The system controlling unit 110a especially controls a system decoder 104a and the image/voice controlling unit 110b controls the image/voice controlling unit 104b and the broadcast program processing unit 108.

The displaying unit 112 displays a next broadcast information data on broadcasting a current program using a next broadcast information data provided by the broadcast program processing unit 108 under the control of the controlling unit 110.

As shown in FIG. 3, the next broadcast information data includes information about the next program title, remaining hours up to the next program, and an image regarding the next program. Also, the next broadcast information data may include at least one or more of the information.

The displaying apparatus according to a first embodiment of the present invention can display a current program and information data regarding a next program with one monitor before a predetermined time which the next program begins.

A first displaying window D1 for a next program information and a second displaying window D2 for a time remaining by the next program information are arranged on an area adjacent to a speaker S. As shown in FIG. 3, on broadcasting a current program, the next broadcast information data (referring to ‘A’) and the current program (referring to ‘B’) can be displayed as one image.

Herein, the next broadcast information may show a ratio of 16 to 9 or 4 to 3 and the current program may show a ratio of 16 to 9 or 4 to 3.

The displaying unit 112 may have a touch screen function and by touching of a point of the displaying unit, a displaying position of the next broadcast information and a displaying position of the current program may be exchanged.

The displaying unit 112 may be implemented one of PMP, PDA, PDP, LCD, and OLED.

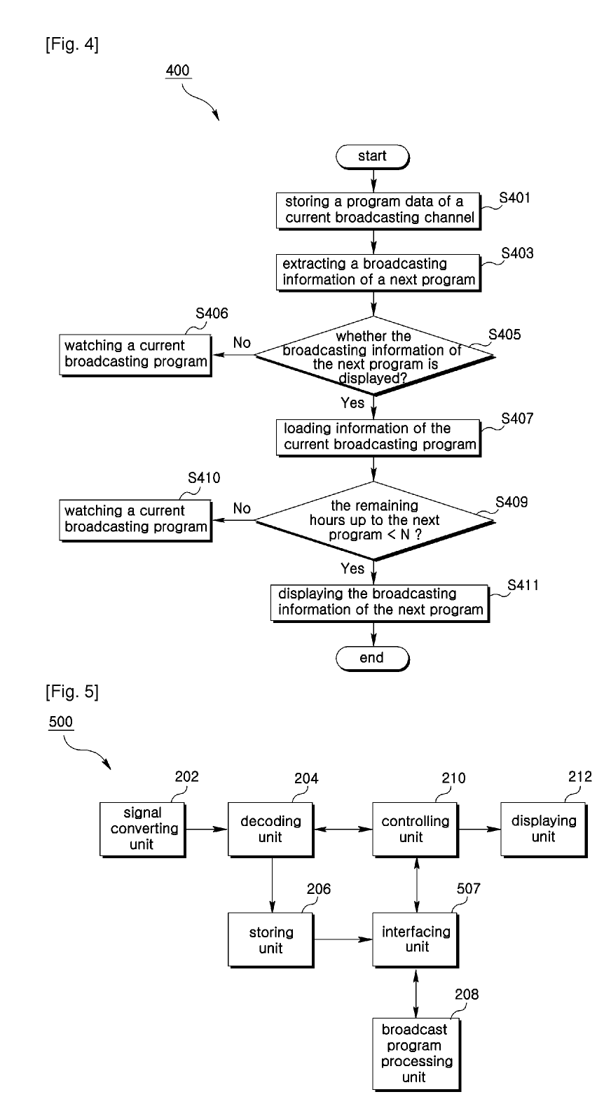

FIG. 4 is a flow chart representing a method for showing a next program a displaying apparatus according to a first embodiment of the present invention.

As shown, according to the method for showing a next program at the displaying apparatus in the first embodiment, a program data of a current channel is received from a broadcasting station and is stored in the storing unit 106 (S401).

The broadcast program processing unit 108 extracts a next program data out of the program data provided by the storing unit 106 (S403).

A step of selecting the next program extracted by the broadcast program processing unit 108 is implemented through the displaying unit 112 (S405).

The method for showing a next program a displaying apparatus according to the first embodiment includes a step of loading the current broadcasting information data from the storing unit 106 if the next program extracted by the broadcast program processing unit 108 is displayed (S407).

The current program is successively displayed if the next program extracted by the broadcast program processing unit 108 is not displayed (S406).

After the step of loading the current broadcasting information data from the storing unit 106, a remaining time by which the next program is broadcasted is calculated and it is checked whether the calculated remaining time is within a predetermined time.

If the calculated remaining time is the predetermined time, information data about the next program is displayed on screen (S411).

For instance, if the predetermined time is 10 minutes, screen area for the next broadcast information data may be activated for 10 minutes before the timing that the current program ends. That is, screen area for the next broadcast information data is activated for 10 minutes before the next program begins. The screen area for the next broadcast information data may have a ratio of 4:3 and if the next program is a Golf program, a first displaying window D1 for the next program information shows ‘PGA Golf’ and the second displaying window D2 for a time remaining by the next program information shows a time within the predetermined time.

On the contrary, if the remaining time is over the predetermined, only the current program is displayed (S410).

The displaying apparatus 100 according to the first embodiment and the method for showing the next program using the same 400 can provide a high quality of broadcast since a user can see beforehand a program information of a next program.

(Second Embodiment)

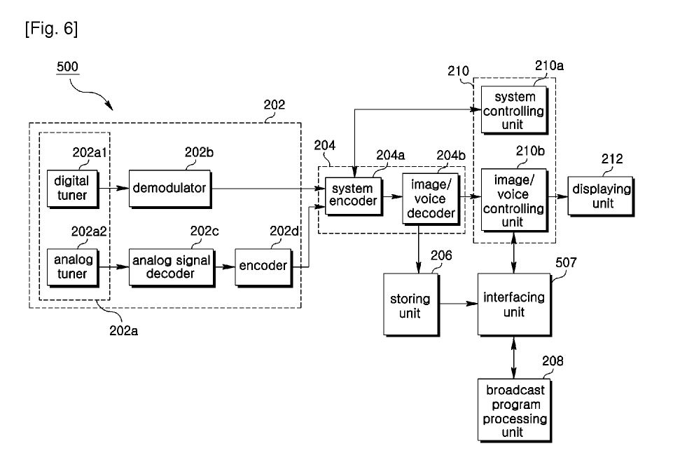

FIG. 5 is an exemplified diagram of displaying apparatus according to a second embodiment of the present invention. FIG. 6 is a detail diagram of the displaying apparatus in FIG. 5.

Referring to FIGS. 5 and 6, the displaying apparatus 500 according to a second embodiment includes a signal converting unit 202, a decoding unit 204, a storing unit 206, a broadcast program processing unit 208, a controlling unit 210, and a displaying unit 212, an interfacing unit 208, and an interfacing unit 507.

Function of and relation between elements which configure the displaying apparatus 500 according to the second embodiment are substantially the same as what is configured in the displaying apparatus 100 according to the first embodiment. Thus, description of operations of elements which are configureed for the displaying apparatus 500 according to the second embodiment are omitted.

The broadcast program processing unit 208 of the displaying apparatus 500 is implemented as an external unit.

The interfacing unit 507 transmits image signals and voice signals provided by broadcast program processing unit 208 to the controlling unit 210 such that the image signals and voice signals are displayed on the displaying unit 212.

Since the broadcast program processing unit 208 is manufactured as an external device, and the displaying apparatus 500 includes the interfacing unit 507, the displaying apparatus 500 can be implemented as a portable device.

Information for a broadcast program can be previously displayed to a user having a portable device. It means that a high quality of broadcasting system can be easily implemented to the user having a portable device.

It will be apparent to those skilled in the art that various modifications and variation can be made in the present invention without departing from the spirit or scope of the invention. Thus, it is intended that the present invention cover the modifications and variations of this invention, provided they come within the scope of the appended claims and their equivalents.

1. A displaying apparatus comprising:
a signal converting unit demodulating a digital signal generated by a tuner and encoding an analog signal decoded by the tuner;
a decoding unit decoding the demodulated digital signal or the encoded analog signal to generate an image signal or a voice signal;
a storing unit storing the image signal or the voice signal;
a broadcast program processing unit providing information of a next program using the image signal or the voice signal while a current program is broadcasted;
a controlling unit controlling the decoding unit and the broadcast program processing unit; and
a displaying unit displaying the information of the next program on broadcasting the current program under the control of the controlling unit.

2. The displaying apparatus of claim 1, wherein the displaying unit displays a current program and the information of the next program with one monitor during a predetermined time before the next program begins.

3. The displaying apparatus of claim 1, further comprising the interfacing unit transmitting the image signal and voice signal provided by the broadcast program processing unit to the controlling unit such that the image signal and voice signal are displayed on the displaying unit wherein the broadcast program processing unit is implemented as a portable unit.

4. The displaying apparatus as in claim 1, wherein the information of the next program includes at least one selected from a group consisting of information about the next program title, remaining hours up to the next program, and an image regarding the next program.

5. The displaying apparatus of claim 1, wherein the displaying unit has a touch screen function and a displaying position of the information of the next program and a displaying position of the current program is exchanged by touching of a point of the displaying unit.

6. The displaying apparatus of claim 1, wherein the signal converting unit includes:
a demodulator demodulating the digital signal provided by the tuner;
an analog decoder decoding the analog signal provided by the tuner; and
an encoder encoding the decoded signal by the analog decoder.

7. The displaying apparatus of claim 6, wherein the decoding unit includes:
A system decoder decoding the demodulated digital signal provided by the demodulator to generate a decoded digital signal or an encoded analog signal provided by the encoder d to generate a decoded analog signal; and
an image/voice decoding unit decoding the decoded digital signal or decoded analog signal provided by the system decoder to generate the image signal or voice signal.

8. The displaying apparatus of claim 7, wherein the controlling unit includes a system controlling unit controlling the system decoder; and
an image/voice controlling unit controlling the image/voice controlling unit and the broadcast program processing unit.

9. The displaying apparatus of claim 1, wherein the displaying unit includes at least one selected from a group consisting of PMP, PDA, PDP, LCD, and OLED.

10. A method for displaying a next program of a broadcast channel, comprising:
storing a program data of a current broadcasting channel;
extracting a broadcasting information of a next program;
selecting whether the broadcasting information of the next program is displayed;
loading information of the current broadcasting program;
calculating a remaining time until the next program is broadcasted;
checking whether the calculated remaining time is within a predetermined time; and
displaying the broadcasting information of the next program if the calculated remaining time is within a predetermined time.

11. The method of claim 10, wherein the predetermined time is 10 minutes and the broadcasting information of the next program is displayed as a ratio of 4:3.

12. The displaying apparatus as in claim 2, wherein the information of the next program includes at least one selected from a group consisting of information about the next program title, remaining hours up to the next program, and an image regarding the next program.

13. The displaying apparatus as in claim 3, wherein the information of the next program includes at least one selected from a group consisting of information about the next program title, remaining hours up to the next program, and an image regarding the next program.
